(19) United States
(12) Patent Application Publication
(10) Pub. No.: US 2025/0373942 A1
(43) Pub. Date: Dec. 4, 2025

(54) IMAGING DEVICE

(71) Applicant: SK hynix Inc., Icheon-si (KR)

(72) Inventors: Yuta SUZUKI, Tokyo (JP); Yuuki ADACHI, Tokyo (JP)

(21) Appl. No.: 18/954,041

(22) Filed: Nov. 20, 2024

(30) Foreign Application Priority Data
Jun. 4, 2024 (KR) 10-2024-0073110

(51) Int. Cl. H04N 23/67; H04N 25/704

(52) U.S. Cl. CPC H04N 23/672; H04N 25/704

(57) ABSTRACT

An imaging device is provided to include a pixel array including phase-difference detection pixels; a position determiner configured to determine a position of each unit pixel; a weight setting unit configured to set different weights for each position of each phase-difference detection pixel based on an output signal of the position determiner; a signal blending unit configured to generate phase images by adding the weight set by the weight setting unit to each phase-difference detection pixel; a parallax calculator configured to calculate a parallax in at least one direction from among a first direction from a center point of an optical axis in the phase images and a second direction from the center point of the optical axis in the phase images; and a focus position determiner configured to generate a driving signal for adjusting a position of a lens based on the parallax calculated by the parallax calculator.

### CROSS-REFERENCE TO RELATED APPLICATION

This patent document claims the priority and benefits of Korean patent application No. 10-2024-0073110, filed on Jun. 4, 2024, the disclosure of which is incorporated herein by reference in its entirety as part of the disclosure of this patent document.

### TECHNICAL FIELD

The technology and implementations disclosed in this patent document generally relate to an imaging device, and more particularly to technology for adjusting a focus position of a camera module through phase detection autofocus (PDAF) pixels.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smart phones, digital cameras, game machines, IoT (Internet of Things), robots, security cameras and medical micro cameras.

### SUMMARY

Various embodiments of the disclosed technology relate to an imaging device that measures parallax in consideration of central symmetry around the optical axis and thus accurately adjusts a focus position in an image sensing device including PDAF pixels.

In accordance with an embodiment of the disclosed technology, an imaging device may include a pixel array configured to include a plurality of image detection pixels configured to detect light from a target object and to output image signals for generating an image of the target object and a plurality of phase-difference detection pixels configured to detect phase difference information in light rays from the target object; a position determiner configured to determine a position of each unit pixel in the pixel array; a weight setting unit configured to set different weights for each position of each phase-difference detection pixel based on an output signal of the position determiner; a signal blending unit configured to generate a plurality of phase images by adding the weight set by the weight setting unit to each of the phase-difference detection pixels; a parallax calculator configured to calculate a parallax in at least one of a first direction proceeding from a center point of an optical axis in the plurality of phase images or a second direction different from the first direction; and a focus position determiner configured to generate a driving signal for adjusting a position of a lens based on the parallax calculated by the parallax calculator.

In accordance with another embodiment of the disclosed technology, an imaging device may include a pixel group including a plurality of unit pixels arranged in a matrix and operable to detect input light from a target object to capture an image of the target object and a plurality of phase-difference detection pixels configured to detect phase difference information in light rays from the target object to produce pixel values carrying the phase difference information; and an image signal processor configured to generate a plurality of phase images by adding different weights for each position of the plurality of unit pixels to the pixel values of the phase-difference detection pixels, and calculate a parallax for the plurality of phase images in at least one of a first direction proceeding from a center point of an optical axis or a second direction perpendicular to the first direction.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging device based on some implementations of the disclosed technology.

FIG. 2 is a diagram illustrating an example structure of a pixel array included in an image sensor shown in FIG. 1 based on some implementations of the disclosed technology.

FIG. 3 is a detailed block diagram illustrating an example of an image signal processor shown in FIG. 1 based on some implementations of the disclosed technology.

FIG. 4 is a diagram illustrating an example of a pixel array for explaining the operation of a position determiner shown in FIG. 3 based on some implementations of the disclosed technology.

FIG. 5 is a schematic diagram illustrating another example for explaining the operation of the position determiner shown in FIG. 3 based on some implementations of the disclosed technology.

FIG. 6 is a diagram illustrating an example of a pixel array for explaining the operation of a weight setting unit shown in FIG. 3 based on some implementations of the disclosed technology.

FIGS. 7(a) to 7(d) show diagrams illustrating phase images for explaining the operation of a signal blending unit shown in FIG. 3 based on some implementations of the disclosed technology.

FIG. 8(a) is a diagram illustrating a method for calculating a radial parallax by the parallax calculator shown in FIG. 3, and FIG. 8(b) is a diagram illustrating a method for calculating a tangential parallax by the parallax calculator shown in FIG. 3.

FIGS. 9(a) to 9(b) and 10(a) to 10(d) are diagrams illustrating example operations for calculating a radial parallax by the parallax calculator shown in FIG. 3 based on some implementations of the disclosed technology.

FIGS. 11(a) to 11(b) and 12(a) to 12(d) are diagrams illustrating example operations for calculating a tangential parallax by the parallax calculator shown in FIG. 3 based on some implementations of the disclosed technology.

### DETAILED DESCRIPTION

This patent document provides implementations and examples of an imaging device capable of adjusting a focus position of a camera module through phase detection autofocus (PDAF) pixels that may be used in configurations to substantially address one or more technical or engineering issues and to mitigate limitations or disadvantages encountered in some other imaging devices. Some implementations of the disclosed technology relate to an imaging device that measures parallax in consideration of central symmetry around the optical axis and thus accurately adjusts a focus position in an image sensing device including PDAF pixels. The disclosed technology provides various implementations of an imaging device that can accurately adjust a focus position in an image sensing device including PDAF pixels.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

For a device (e.g., a camera) for photographing a target object, it is important to accurately focus on the target object in order to capture a clear image (e.g., a still image) or video (e.g., moving images). The image sensing device includes a phase-difference detection autofocus (PDAF) function that automatically focuses based on an operation using the phase difference detection for detecting a phase difference in light received by adjacent phase-difference detection pixels. The phase detection autofocus (PDAF) method is a method of measuring the offset direction and the offset amount from a central image that is acquired through the image sensing device using a phase difference between two or more different measurement points.

Recently, in order to improve the PDAF function, a structure in which a plurality of pixels of the same color is arranged adjacent to each other and one microlens is applied to the plurality of pixels has been used in the image sensing device. However, in the image sensing device in which a single microlens is applied to a plurality of pixels, parallax is changed due to astigmatism of the lens, making it difficult to accurately perform an autofocus operation.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

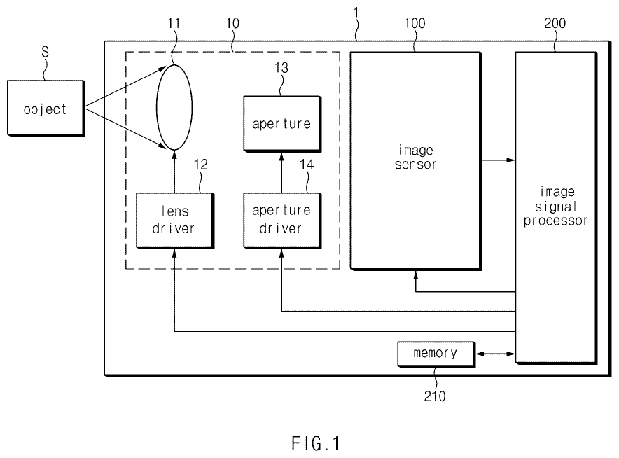

FIG. 1 is a block diagram illustrating an example of an imaging device 1 based on some implementations of the disclosed technology. The imaging device 1 (e.g., a camera) may capture a photo image (or moving images) of a target object by collecting light reflected from the target object. A method for performing the autofocus (AF) function by the image sensing device ISD will hereinafter be described with reference to FIG. 1.

Referring to FIG. 1, the imaging device 1 may refer to a device, for example, a digital still camera for photographing still images or a digital video camera for photographing moving images. For example, the imaging device 1 may be implemented as a Digital Single Lens Reflex (DSLR) camera, a mirrorless camera, or a smartphone, and others. The imaging device 1 may include a device provided with a plurality of camera modules, each of which has both a lens and an image pickup element, such that the device can capture (or photograph) a target object and can thus create an image of the target object.

Referring to FIG. 1, the imaging device 1 may include an imaging circuit 10, an image sensor 100, an image signal processor (ISP) 200, and a memory 210.

In this case, the imaging circuit 10 may be a component that receives light. In more detail, the imaging circuit 10 may include a lens 11, a lens driver 12, an aperture 13, and an aperture driver 14.

The lens 11 may converge light that is reflected from the target object S and reaches the imaging device 1. While FIG. 1 shows the single lens, other implementations are also possible. For example, in some implementations, a lens assembly can be provided, which include aligned in the optical axis direction. As the position of the lens 11 is adjusted, the focus on the target object S may change. The position of the lens 11 may be based on signals generated from pixels of the image sensor 100.

The lens driver 12 may control the position of the lens 11 based on a control signal from the image signal processor 200. In some implementations, the lens driver 12 may adjust a focal distance by adjusting the position of the lens 11, and may perform operations such as autofocus, zoom change, and focus change. As the position of the lens 11 is adjusted, the distance between the lens 11 and the target object S can be adjusted. For example, the lens driver 12 may move the lens 11 in a direction parallel to the optical axis direction.

The degree of opening and closing of the aperture 13 may be adjusted based on a control signal from the aperture driver 14, and may control the amount of light to be incident upon the lens 11. As the amount of light (i.e., the amount of reception light) to be incident upon the lens 310 is adjusted through the aperture 13, the magnitude of signals generated by the image sensor 100 can be adjusted in response to the adjusted amount of light.

The aperture driver 14 may control the aperture 13, such that the aperture driver 14 can adjust the amount of light to be incident upon the lens 11 using the aperture 13. For example, the aperture driver 14 may move the lens 11 in the direction parallel to the light output direction. The optical signal passing through the lens 11 and the aperture 13 may reach a light reception surface of the image sensor 100, resulting in the formation of an image of the target object S.

The image sensor 100 may include a pixel array (to be described later) in which a plurality of unit pixels is arranged in columns and rows. For example, the plurality of unit pixels is two-dimensionally arranged in a grid shape.

The image sensor 100 may generate a digital signal (or electrical signal) based on light reflected from the target object, and may generate digital image data (hereinafter referred to as “image data”) based on the electrical signal. Incident light (i.e., optical signal) that has penetrated the lens 11 and the aperture 13 may be imaged in the pixel array and may be converted into an electrical signal. Each of the unit pixels (to be described later) may generate an electrical signal corresponding to the external object S.

In some embodiments, the image sensor 100 may include a photodiode (PD), a transfer transistor, a reset transistor, and a floating diffusion node (FD). The photodiode (PD) may generate and accumulate photocharges corresponding to the optical image of the target object S. While the photodiode (PD) is mentioned as the element of the image sensor 100, any photoelectric conversion element can be used without being limited to the photodiode as long as the photoelectric conversion elements converts an optical signal or incident light to an electrical signal. For example, the photoelectric conversion element may include, e.g., a photodiode, a photo transistor, a photo gate, or other photosensitive circuitry capable of converting light into a pixel signal (e.g., a charge, a voltage or a current). The transfer transistor may transmit photocharges focused on the photodiode (PD) to the floating diffusion node (FD) in response to a transfer signal. The reset transistor may discharge charges stored in the floating diffusion node (FD) in response to a reset signal. Before the reset signal is applied to the image sensor, charges stored in the floating diffusion node (FD) can be output. At this time, correlated double sampling (CDS) processing may be performed, and CDS-processed analog signals may be converted into digital signals through analog-to-digital conversion (ADC) processing and/or analog front end (AFE) processing. An example of the image sensor 100 according to the present disclosure may be configured such that four photodiodes are allocated to a unit pixel corresponding to a single microlens (for example, a four-photodiode (4PD) pixel structure).

The unit pixels may be arranged in a matrix form in a pixel array. Each of the electrical signals generated by the unit pixels may include an image signal and a phase signal for the target object S. In this case, the image signal may be a signal generated in response to light from the target object S incident on the image sensor 100, and may be used as a signal to generate an image of the target object S. In addition, the phase signal may be a signal generated in response to light from the target object S incident on the image sensor 100, and may be used as a signal to adjust the distance between the target object S and the lens 11. The unit pixels may be classified into phase-difference detection pixels or image detection pixels depending on the output signals thereof. For example, the phase difference detection pixels refer to the unit pixels outputting the phase signals and the image detection pixels refer to the unit pixels outputting the image signals.

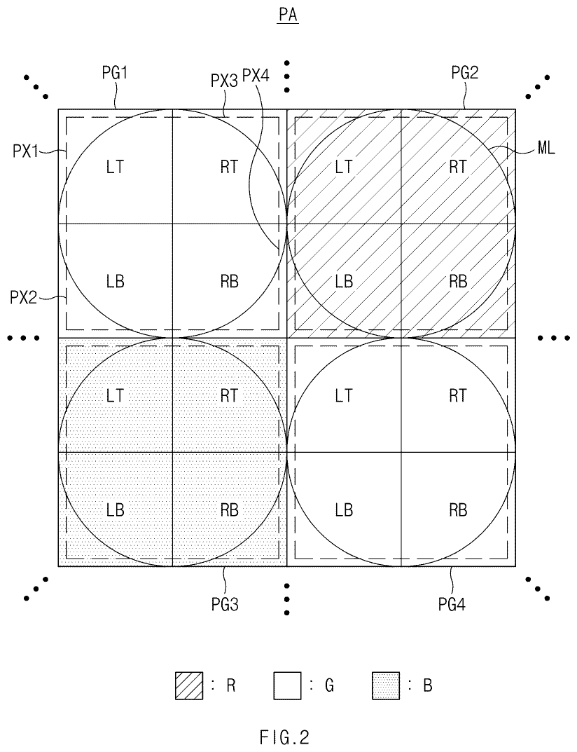

The phase-difference detection pixels may be arranged in an (N×N) matrix shape (where ‘N’ is a natural number or a positive integer of 2 or greater). The image detection pixels may be arranged adjacent to the phase-difference detection pixels. A detailed structure of the unit pixels will be described below in more detail with reference to FIG. 2.

The image signal processor 200 may obtain image information, etc. based on signals output from the image detection pixels. The image signal processor 200 may obtain phase information, etc. based on signals output from the phase-difference detection pixels.

In some implementations, the image signal processor 200 may receive image data from the image sensor 100 and may generate phase data (phase images). In addition, the image signal processor 200 may process a phase difference calculation to be used in the autofocus operation based on phase data. The image signal processor 200 may obtain the position and direction of a focus and the distance between the target object S and the imaging device 1 through such phase difference calculation. The image signal processor 200 may provide a driving signal for adjusting the value of the aperture 13 to the aperture driver 14 based on a result of the phase difference calculation. Additionally, the image signal processor 200 may provide a driving signal for adjusting the position of the lens 11 to the lens driver 12 based on a result of the phase difference calculation.

The image signal processor 200 may perform various image data processes for improving the image quality, for example, noise reduction, gain adjustment, waveform shaping, analog-to-digital conversion (ADC), interpolation, a white balance process, a gamma process, and/or an edge sharpening process, etc. In some implementations, the image signal processor 200 may change a region of interest (ROI) for the image based on information about the detected focus and information about the image of the target object.

Although the embodiment of FIG. 1 has disclosed that the image signal processor 200 is shown as being provided outside the image sensor 100, other implementations are also possible, and it should be noted that the image signal processor 200 can be provided inside the image sensor 100 or separately provided outside the imaging device 1.

The memory 210 may store at least a portion of the image acquired through the image sensor 100 for the next image processing task, or may store commands or data related to the image signal processor 200. In some implementations, the memory 210 may store at least one piece of correction data (e.g., white balance correction data, gamma correction data, knee correction data, parallax, lens driving amount, etc.). For example, the at least one piece of correction data may be stored in a look-up table (LUT) format.

Although FIG. 1 illustrates that the memory 210 is shown as being provided outside the image signal processor 200 for convenience of description, other implementations are also possible, and it should be noted that the memory 210 may also be provided inside the image signal processor 200.

When there is no phase difference between signals generated by the phase-difference detection pixels included in the image sensor 100, the distance between the lens 11 and the target object S may be referred to as being at “in-focus position”. When the distance between the lens 11 and the target object S is at the in-focus position, the magnitudes of the incident lights that have reached the unit pixels after passing through one microlens may be equal to each other, so that the magnitudes of signals respectively detected from the unit pixels sharing one microlens may also be equal to each other. For example, when the lens 11 and the target object S are at the in-focus position, the phase difference between the phase signals detected by the phase-difference detection pixels included in the pixel array become zero.

If the distance between the lens 11 and the target object S is not at the in-focus position, a difference may occur between signals generated by the phase-difference detection pixels. The magnitude of incident light reaching each unit pixel may vary depending on the positions of the unit pixels within the pixel group. This is because a path difference may occur in the incident light passing through the microlens.

Accordingly, when the distance between the lens 11 and the target object S is not at the in-focus position, the magnitudes of the phase signals of the respective unit pixels collected by the image signal processor 200 may be different from each other. When the distance between the lens 11 and the target object S is not at the in-focus position, the image signal processor 200 may generate phase data by calculating a difference in magnitude between phase signals.

The image signal processor 200 may provide a driving signal to the lens driver 12 based on such phase data. Based on the driving signal provided from the image signal processor 200, the lens driver 12 may move the lens 11 so that the distance between the lens 11 and the target object S is at the in-focus position.

In order to improve the autofocus (AF) performance in high-resolution images, image sensing devices, each of which has a structure in which one microlens is applied to a plurality of pixels (to be described later in FIG. 2), are being developed. Since the image sensing devices have different focus positions depending on the position of the target object, the focus adjustment is performed using parallax of the selected ROI position.

However, disparity may change due to effects such as astigmatism of the lens, making it difficult to accurately perform autofocus. The bundles of light rays emitted from an object point pass through the imaging optical system (lens) and are collected and detected by the image sensor 100 to create an image. Such an image contains a desired image distortions including distortions caused by optical astigmatism of the imaging lens which refers to a phenomenon where an image point where the bundles of light rays spreading vertically are collected becomes different in position from an image point where the bundles of light rays spreading horizontally are collected, so that the image of object points appears as a shape instead of a stigmatic point. This astigmatism ultimately occurs when the imaging optical system contains some level of a rotational asymmetry, and such astigmatism may result from two causes. First, the imaging optical system itself is rotationally symmetric, but the imaging conditions destroy such rotational symmetry. Second, the imaging optical system itself is not rotationally symmetric.

Since the focus position is different depending on the texture directions of incident light rays forming the image, it is difficult to determine the focus position where parallax becomes zero ‘0’ within the region of interest (ROI). Additionally, since the focus is adjusted using parallax in the same direction (e.g., in left and right directions of the image) regardless of the position of the image, the central symmetry of the imaging device around the optical axis may be destroyed. In this case, focus adjustment performance may not be uniform in the region of interest (ROI) that deviates from the center point of the image.

Accordingly, the imaging device based on some implementations of the disclosed technology calculates parallax in consideration of central symmetry about the optical axis, so that detection of each focus in two directions of astigmatism (i.e., the radial and tangential directions to be described later) may be possible and spatial uniformity of focus adjustment performance around the optical axis can be improved. In the present embodiment, the operation of calculating parallax in consideration of central symmetry will be described in more detail with reference to FIGS. 2 to 12 to be described later.

FIG. 2 is a diagram illustrating an example structure of the pixel array included in the image sensor 100 shown in FIG. 1 based on some implementations of the disclosed technology.

Referring to FIG. 2, 16 unit pixels arranged in a matrix including 4 rows and 4 columns are shown. For example, 16 unit pixels are a minimum unit of the pixel array PA, and the 16 unit pixels may be repeated in the row and column directions, but the scope or spirit of the disclosed technology is not limited thereto.

The pixel array PA of the image sensor 100 may include pixel groups (PG1˜PG4). The pixel groups (PG1˜PG4) may be arranged in an (N×N) matrix (where ‘N’ is a natural number or a positive integer of 2 or greater). The pixel groups (PG1, PG4) may be arranged diagonally from each other, and the pixel groups (PG2, PG3) may be arranged diagonally from each other.

One microlens ML (which may correspond to the lens 11 of FIG. 1) may be formed in each of the pixel groups (PG1˜PG4). For example, since four unit pixels (PX1˜PX4) share one microlens (ML), this shared structure may be referred to as an A4C (All 4-coupled) structure. The microlens (ML) may adjust the path of light incident upon the image sensor 100.

Each of the pixel groups (PG1˜PG4) may have four unit pixels (PX1˜PX4) having the same color, and the four unit pixels (PX1˜PX4) are arranged adjacent to each other in an (N×N) matrix (where ‘N’ is a natural number or a positive integer of 2 or greater). When four light reception elements are placed in each of the pixel groups (PG1˜PG4), the four light reception elements may be arranged symmetrically in the upper right/upper left/lower right/lower left directions based on the center of each pixel group. The four light reception elements may correspond to the four unit pixels (PX1˜PX4), respectively.

For example, the pixel group PG1 may include four unit pixels each having a green (Gr) color filter. The pixel group PG2 may include four unit pixels each having a red (R) color filter. Additionally, the pixel group PG3 may include four unit pixels each having a blue (B) color filter. The pixel group PG4 may include four unit pixels each having a green (Gb) color filter.

In the implementation, each of the pixel groups (PG1˜PG4) may include four unit pixels (PX1˜PX4). Each of the unit pixels (PX1˜PX4) may include one photoelectric conversion element (not shown) corresponding to each unit pixel. Colors (i.e., red (R), green (Gr, Gb), blue (B)) corresponding to pixel groups (PG1˜PG4) may be arranged in a Bayer pattern. Accordingly, raw images generated by capturing images by the image sensor 100 may include color image pixels arranged in a structure similar to the above-described pixel array (PA). The repetitive arrangement structure and pattern of the pixel array PA are not limited thereto and may vary depending on the embodiments.

The positions where the red pixel, blue pixel, and/or green pixel are placed within each pixel group (PG1˜PG4) may be equal to each other to reduce the amount of calculation required for image signal processing by the image signal processor 200, but other implementations are also possible. In some implementations, although the present embodiment has disclosed that each of the pixel groups (PG1˜PG4) includes four unit pixels (PX1˜PX4) for convenience of description, the number of unit pixels included in each pixel group is not limited thereto.

The unit pixels included in the pixel array PA may be used to generate signals corresponding to the target object S of FIG. 1 and to generate phase signals for autofocus by capturing the target object S. Each of the phase signals may include information about the position of the unit pixel (that generates the phase signal) on the pixel array PA. The phase signals may be transmitted to the image signal processor 200 and may be used to detect the distance between the target object S and the lens 11. The autofocus operation through phase detection may detect a phase difference between images generated by the unit pixels, may calculate the movement distance of the lens from the detected phase difference, may adjust the position of the lens based on the calculated movement distance, and may obtain an in-focus image.

In FIG. 2, English letters (LT, LB, RT, RB) written in each unit pixel (PX1˜PX4) may indicate the positions of the four unit pixels within the corresponding pixel group (PG), respectively. For example, in each pixel group (PG1˜PG4), the position of the unit pixel (PX1) located at the upper left corner will hereinafter be referred to as “LT (Left Top)”, and the position of the unit pixel (PX2) located at the lower left corner will hereinafter be referred to as “LB (Left Bottom)”. In addition, the position of the unit pixel (PX3) located at the upper right corner of each pixel group (PG1˜PG4) will hereinafter be referred to as “RT (Right Top)”, and the position of the unit pixel (PX4) located at the lower right corner will hereinafter be referred to as “RB (Right Bottom)”.

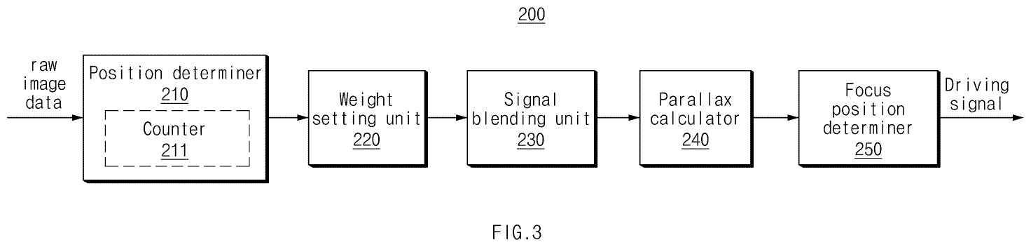

FIG. 3 is a detailed block diagram illustrating an example of the image signal processor 200 shown in FIG. 1 based on some implementations of the disclosed technology.

Referring to FIG. 3, the image signal processor 200 may include a position determiner 210, a weight setting unit 220, a signal blending unit 230, a parallax calculator 240, and a focus position determiner 250.

In this case, the position determiner 210 may determine the position of each of the pixel groups (PG1˜PG4) in the pixel array PA. The position determiner 210 may determine where the pixel group (e.g., PG1) including the phase-difference detection pixels (PX1˜PX4) from among the pixel groups (PG1˜PG4) in the pixel array PA is located on the image.

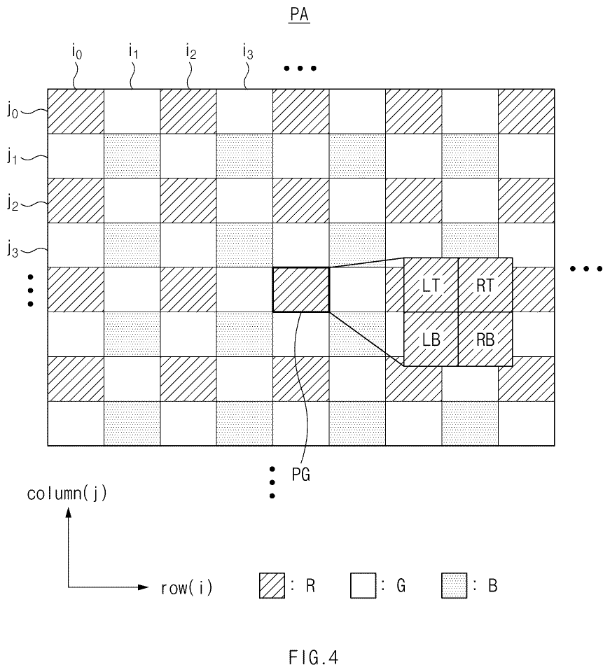

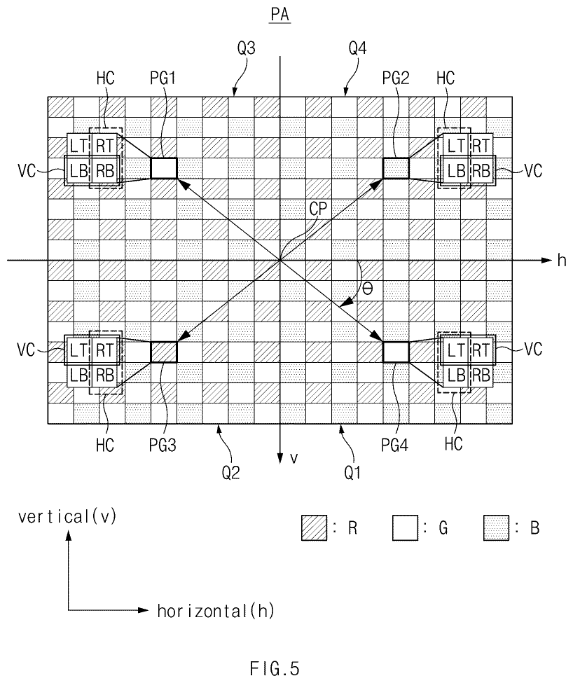

For example, the position determiner 210 may detect the position of a pixel while counting all unit pixels (PXs) of the pixel array PA using the counter 211. The operation of determining the position of the pixel by the position determiner 210 will be described below in more detail with reference to examples in FIG. 4 and FIG. 5.

In some other implementations, the position determiner 210 may use information about an angle between the optical axis of the pixel array PA and the target pixel group when determining the position of each pixel. For example, when pixel values in radial and tangential directions are used as a linear sum of phase-difference detection pixels, position information can be expressed as a function of angle. Therefore, the position determiner 210 may output angle information as pixel position information. The operation of detecting the position of each pixel by the position determiner 210 using angle information will be described in more detail with reference to FIG. 5 to be described later.

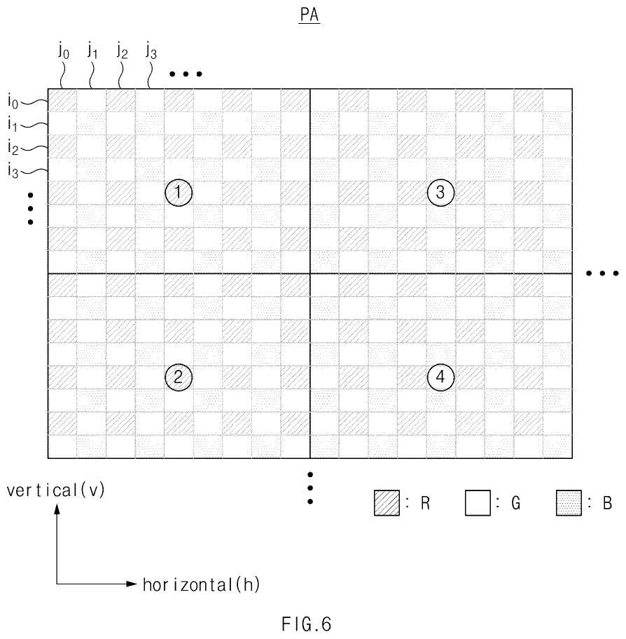

The weight setting unit 220 may determine a weight for each position (LT, LB, RT, RB) of the phase-difference detection pixels (PX1˜PX4) based on the position information of the pixel group detected by the position determiner 210. In some implementation, the weight to be applied to the phase-difference detection pixels (PX1˜PX4) can be determined differently for each position (LT, LB, RT, RB) of the phase-difference detection pixels (PX1˜PX4). In some other implementations, the weight to be applied to the phase-difference detection pixels (PX1˜PX4) may be determined differently in response to angle information of the phase-difference detection pixels (PX1˜PX4) with respect to the optical axis. The operation of determining the weight by the weight setting unit 220 will be described in more detail with reference to FIG. 6 to be described later.

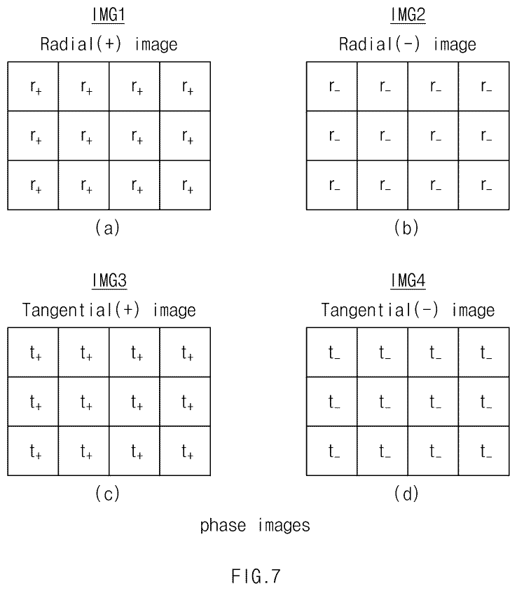

The signal blending unit 230 may generate a plurality of phase images by blending the weight determined by the weight setting unit 220 with the pixel values of the phase-difference detection pixels (PX1˜PX4). For example, the signal blending unit 230 may perform an operation of adding a weight to the input pixel data. The operation of the signal blending unit 230 will be described in more detail with reference to FIGS. 7(a) to 7(d) to be described later.

The parallax calculator 240 may calculate parallax from a plurality of phase images generated by the signal blending unit 230, and may output a disparity value corresponding to the calculated parallax. For example, the parallax calculator 240 may calculate a parallax using a cross correlation method. In addition, the parallax calculator 240 may calculate the radial parallax and/or the tangential parallax from the center point of the optical axis.

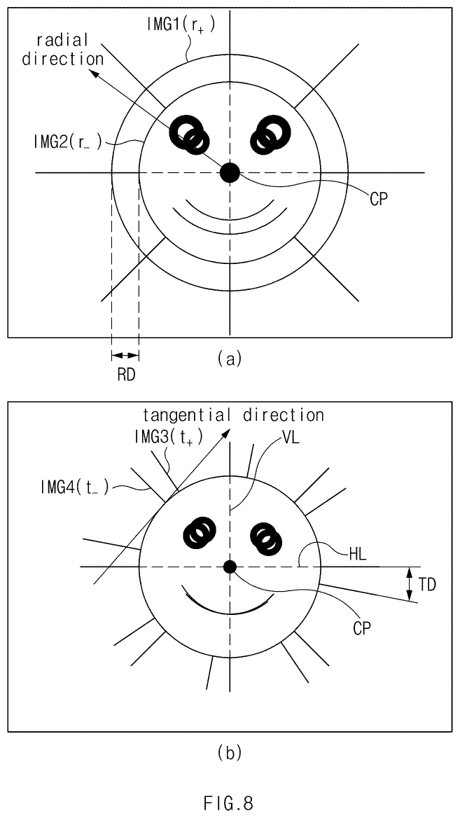

Although the present embodiment has disclosed a method for calculating the radial parallax and the tangential parallax for convenience of description, other implementations are also possible, and it should be noted that parallax can also be calculated with reference to other directions. The operation of the parallax calculator 240 will be described in more detail with reference to FIGS. 8 to 12 to be described later.

The focus position determiner 250 may output a driving signal for determining the focus position of the lens 11 to the lens driver 12 based on the parallax value calculated by the parallax calculator 240. The focus position determiner 250 may adjust the position of the lens 11 to set the disparity to zero ‘0’ based on the parallax value calculated by the parallax calculator 240. For example, the focus position determiner 250 may store the parallax information and lens driving amount that are calculated by the parallax calculator 240 in the look-up table (LUT) of the memory 210, and may control the lens driver 12 using the data stored in the look-up table (LUT).

FIG. 4 is a diagram illustrating an example of a pixel array for explaining the operation of the position determiner 210 shown in FIG. 3 based on some implementations of the disclosed technology.

Referring to FIG. 4, the pixel array PA may be formed by arranging raw image data in a Bayer pattern. As described above with reference to FIG. 2, the pixel array PA is configured such that pixel groups (PGs) including unit pixels (i.e., red pixels, blue pixels, or green pixels) are repeatedly arranged in the row and column directions.

In the pixel array PA, each index of pixel groups arranged in the row direction may be set to ‘i’, and each index of pixel groups arranged in the column direction may be set to ‘j’. Here, the index (i) may be greater than or equal to zero ‘0’ and may be less than or equal to ‘h−1’. In this case, ‘h’ may represent the number of pixels (i.e., the cell size in the horizontal direction) in the horizontal direction (i.e., the row direction) in the pixel array (PA). In addition, the index (j) may be greater than or equal to ‘0’ and may be less than or equal to ‘v−1’. Here, ‘v’ may represent the number of pixels (i.e., the cell size in the vertical direction) in the vertical direction (i.e., the column direction) within the pixel array PA. The pixel groups arranged in the row direction may be denoted by ‘i0’, ‘i1’, ‘i2’, and ‘i3’, and pixel groups arranged in the column direction may be denoted by ‘j0’, ‘j1’, ‘j2’, and ‘j3’.

The position determiner 210 may detect the position of the raw image data in the pixel array PA, and may detect where a pixel group (e.g., PG1 of FIG. 2) including the phase-difference detection pixels (e.g., PX1, PX2, PX3 and PX4 in FIG. 2) among the pixel groups (PG1˜PG4) is located in the image. The position determiner 210 may determine the position of the corresponding pixel group by reading out data for all unit pixels of the pixel array PA.

For example, when the count value of the counter 211 is zero ‘0’, the position determiner 210 may output the position values (i, j) of the pixel group corresponding to ‘i₀’ and ‘j₀’. In addition, when the count value of the counter 211 is ‘1’, the position determiner 210 may output the position values (i, j) of the pixel group corresponding to ‘i₀’ and ‘j₁’. When the read-out operation for one line ‘i₀’ (one row line) is completed, an operation for detecting the pixel position for the next line ‘i₁’ may be performed.

As described above, the position determiner 210 sequentially reads out the data of all pixel groups (PG) while increasing the count value of the counter 211 by ‘1’ and outputs coordinate values (i, j) for the position value. When the counting operation for all pixel groups (PG) in the pixel array PA is completed, the counter 211 may be reset to zero ‘0’ again.

FIG. 5 is a schematic diagram illustrating another example for explaining the operation of the position determiner 210 shown in FIG. 3 based on some implementations of the disclosed technology.

Referring to FIG. 5, the position determiner 210 may determine the position of the pixel group (e.g., (i, j) coordinates) with respect to all pixels (PXs) in the pixel array PA, and may output angle information between the optical axis and the pixel group (PG1˜PG4) corresponding to a target region as position information of the pixel group.

For example, in the pixel array (PA), a line that crosses the center point (CP) of the optical axis in the horizontal direction may be defined as a horizontal line (h), and a line that crosses the center point (CP) of the optical axis in the vertical direction may be defined as a vertical line (v).

When the region is divided into a vertical line (v) and a horizontal line (h) based on the center point (CP) of the optical axis, the pixel array PA can be divided into four regions (Q1˜Q4) (i.e., first, second, third, and fourth quadrants). The first region Q1 may be located in the first quadrant located at the lower right side based on the center point (CP). The second region Q2 may be located in the second quadrant located at the lower left side based on the center point CP. The third region Q3 may be located in the third quadrant located at the upper left side based on the center point CP. The fourth region Q4 may be located in the fourth quadrant located at the upper right side based on the center point CP. Although the present embodiment has disclosed the positions of the four regions (Q1˜Q4), the positions of the four corresponding regions (Q1˜Q4) in the first to fourth quadrants may vary, and the number of distinct regions may also vary.

Each pixel group (PG) may include a plurality of unit pixels (PX1˜PX4) sharing one microlens. The unit pixels (PX1˜PX4) can be defined as an LT (Left Top) pixel region, an LB (Left Bottom) pixel region, an RT (Right Top) pixel region, and an RB (Right Bottom) pixel region, as described above with reference to FIG. 2.

In the embodiment of FIG. 5, a pair of pixels (hereinafter referred to as a pixel pair) located closest in the vertical direction with respect to the horizontal line (h) from among the pixel regions (LT, LB, RT, RB) will hereinafter be denoted by a vertically-close solid line (VC). Among the pixel regions (LT, LB, RT, RB), the pixel pair located closest in the horizontal direction based on the vertical line (v) will hereinafter be denoted by a horizontally-close dotted line (HC).

The positions of the pixel regions (LT, LB, RT, RB) closest to or farthest from the optical axis in each region (Q1˜Q4) will be described with reference to Table 1 below.

TABLE 1

| Position of Pixel Region | |
|---|---|
| from Optical Axis | Corresponding pixel region |
| nₕnᵥ | LT(Q1), RT(Q2), RB(Q3), LB(Q4) |
| nₕfᵥ | LB(Q1), RB(Q2), RT(Q3), LT(Q4) |
| fₕnᵥ | RT(Q1), LT(Q2), LB(Q3), RB(Q4) |
| fₕfᵥ | RB(Q1), LB(Q2), LT(Q3), RT(Q4) |

For example, ‘nₕnᵥ’ may represent a pixel region located closest to the optical axis in the horizontal and vertical directions. That is, it can be seen that the LT pixel region corresponds to the position ‘nₕnᵥ’ in the Q1 region, the RT pixel region corresponds to the position ‘nₕnᵥ’ in the Q2 region, the RB pixel region corresponds to the position ‘nₕnᵥ’ in the Q3 region, and the LB pixel region corresponds to the position ‘nₕnᵥ’ in the Q4 region.

‘nₕfᵥ’ may represent a pixel region that is located closest to the optical axis in the horizontal direction and is located farthest from the optical axis in the vertical direction. That is, it can be seen that the LB pixel region corresponds to the position ‘nₕfᵥ’ in the Q1 region, the RB pixel region corresponds to the position ‘nₕfᵥ’ in the Q2 region, the RT pixel region corresponds to the position ‘nₕfᵥ’ in the Q3 region, and the LT pixel region corresponds to the position ‘nₕfᵥ’ in the Q4 region.

‘fₕnᵥ’ may represent a pixel region that is located farthest from the optical axis in the horizontal direction and is located closest to the optical axis in the vertical direction. That is, it can be seen that the RT pixel region corresponds to the position ‘fₕnᵥ’ in the Q1 region, the LT pixel region corresponds to the position ‘fₕnᵥ’ in the Q2 region, the LB pixel region corresponds to the position ‘fₕnᵥ’ in the Q3 region, and the RB pixel region corresponds to the position ‘fₕnᵥ’ in the Q4 region.

In addition, ‘fₕfᵥ’ may represent a pixel region that is located farthest from the optical axis in the horizontal and vertical directions. That is, it can be seen that the RB pixel region corresponds to the position ‘fₕfᵥ’ in the Q1 region, the LB pixel region corresponds to the position ‘fₕfᵥ’ in the Q2 region, the LT pixel region corresponds to the position ‘fₕfᵥ’ in the Q3 region, and the RT pixel region corresponds to the position ‘fₕfᵥ’ in the Q4 region.

The angle at which each pixel group (PG1˜PG4) is located based on the center line (CP) of the optical axis (i.e., the horizontal line (h) or the vertical line (v)) of the image will hereinafter be defined as “θ”. Therefore, the position determiner 210 may calculate the angle ‘θ(i, j)’ according to the pixel position (i, j), and may output the calculated angle ‘θ(i, j)’ to the weight setting unit 220.

FIG. 6 is a diagram illustrating an example of a pixel array for explaining the operation of the weight setting unit 220 shown in FIG. 3 based on some implementations of the disclosed technology.

Referring to FIG. 6, the weight setting unit 220 may determine a weight for each position (LT,LB,RT,RB) of the unit pixel based on the position value (i, j) of the pixel group (PG) in the pixel array (PA). That is, the weight setting unit 220 may set different weights for each position of each unit pixel to calculate the parallax in a specific direction (e.g., the radial direction and/or the tangential direction).

For example, the region of the pixel array PA may be divided into four regions (i.e., \textcircled{1} region, \textcircled{2} region, \textcircled{3} region, \textcircled{4} region), and the weight may be set differently for each position (LT, LB, RT, RB) of each unit pixel within each region. Here, the region \textcircled{1} and the region \textcircled{3} may refer to upper regions located above the center position of the horizontal direction (h), and the region \textcircled{2} and the region \textcircled{4} may refer to lower regions located below the center position of the horizontal direction (h). In addition, the region \textcircled{1} and the region \textcircled{2} may refer to left regions located to the left from the center position of the vertical direction (v), and the region \textcircled{3} and the region \textcircled{4} may refer to right regions located to the right from the center position of the vertical direction (v).

The method of determining the weight ‘wₘₙ’ (where each of ‘m’ and ‘n’ can be set to 1, 2, 3, and 4) by the weight setting unit 220 can be determined as represented by Equations 1 to 4. In the following description for the embodiment of FIG. 4, a method of determining (or setting) a weight by the position determiner 210 that receives coordinates (i, j) for a position value may be implemented as an example of various implementations.

$$\{ {w}_{mn} ( i , j ) \} = [ \begin{matrix}1 & 0 & 0 & 0 \\ 0 & 0 & 0 & 1 \\ 0 & 1 & 0 & 0 \\ 0 & 0 & 1 & 0\end{matrix} ] \qquad [ Equation 1 ]$$

The weight setting unit 220 may set the weight ‘wₘₙ’ for the position value (i, j) in the region \textcircled{1} as shown in Equation 1 above.

$$\{ {w}_{mn} ( i , j ) \} = [ \begin{matrix}0 & 0 & 1 & 0 \\ 0 & 1 & 0 & 0 \\ 1 & 0 & 0 & 0 \\ 0 & 0 & 0 & 1\end{matrix} ] \qquad [ Equation 2 ]$$

The weight setting unit 220 may set the weight ‘wₘₙ’ for the position value (i, j) in the region \textcircled{2} as shown in Equation 2 above.

$$\{ {w}_{mn} ( i , j ) \} = [ \begin{matrix}0 & 1 & 0 & 0 \\ 0 & 0 & 1 & 0 \\ 0 & 0 & 0 & 1 \\ 1 & 0 & 0 & 0\end{matrix} ] \qquad [ Equation 3 ]$$

The weight setting unit 220 may set the weight ‘wₘₙ’ for the position value (i, j) in the region \textcircled{3} as shown in Equation 3 above.

$$\{ {w}_{mn} ( i , j ) \} = [ \begin{matrix}0 & 0 & 0 & 1 \\ 1 & 0 & 0 & 0 \\ 0 & 0 & 1 & 0 \\ 0 & 1 & 0 & 0\end{matrix} ] \qquad [ Equation 4 ]$$

The weight setting unit 220 may set the weight ‘wₘₙ’ for the position value (i, j) in the region \textcircled{4} as shown in Equation 4 above.

The matrix of the weight ‘wₘₙ’ determined by the weight setting unit 220 can be expressed in the same order as in Equation 5 below.

$$\{ {w}_{mn} ( i , j ) \} = [ \begin{matrix}{w}_{11} & {w}_{12} & {w}_{13} & {w}_{14} \\ {w}_{21} & {w}_{22} & {w}_{23} & {w}_{24} \\ {w}_{31} & {w}_{32} & {w}_{33} & {w}_{34} \\ {w}_{41} & {w}_{42} & {w}_{43} & {w}_{44}\end{matrix} ] \qquad [ Equation 5 ]$$

In some other implementations, the method of determining the weight ‘wₘₙ’ (where each of ‘m’ and ‘n’ can be set to 1, 2, 3, and 4) by the weight setting unit 220 can be determined as represented by Equations 6 to 9. In the following description as described in the above-described embodiment of FIG. 5, a method of determining (or setting) the weight by the position determiner 210 that receives the angle ‘θ(i, j)’ for a position value will be described as an example.

$${w}_{11} ( θ ) = 0 \qquad [ Equation 6 ]$$

$${w}_{12} ( θ ) = 1 / 2 \vert sin θ \vert$$

$${w}_{13} ( θ ) = 1 / 2 \vert cos θ \vert$$

$${w}_{14} ( θ ) = 1 / 2 \vert cos θ \vert + 1 / 2 \vert sin θ \vert$$

Equation 6 above may represent a method for determining the weights (W11˜W14) by the weight wetting unit 220.

$${w}_{21} ( θ ) = 1 / 2 \vert cos θ \vert + 1 / 2 \vert sin θ \vert \qquad [ Equation 7 ]$$

$${w}_{22} ( θ ) = 1 / 2 \vert cos θ \vert$$

$${w}_{23} ( θ ) = 1 / 2 \vert sin θ \vert$$

$${w}_{24} ( θ ) = 0$$

Equation 7 above may represent a method for determining the weights (W21˜W24) by the weight setting unit 220.

$${w}_{31} ( θ ) = \{ \begin{matrix}1 / 2 \vert cos θ \vert & ( second and fourth quadrants ) \\ 1 / 2 \vert sin θ \vert & ( first and third quadrants )\end{matrix} \qquad [ Equation 8 ]$$

$${w}_{32} ( θ ) = \{ \begin{matrix}1 / 2 \vert cos θ \vert + 1 / 2 \vert sin θ \vert & ( first and third quadrants ) \\ 0 & ( second and fourth quadrants )\end{matrix}$$

$${w}_{33} ( θ ) = \{ \begin{matrix}1 / 2 \vert cos θ \vert + 1 / 2 \vert sin θ \vert & ( second and fourth quadrants ) \\ 0 & ( first and third quadrants )\end{matrix}$$

$${w}_{34} ( θ ) = \{ \begin{matrix}1 / 2 \vert cos θ \vert & ( first and third quadrants ) \\ 1 / 2 \vert sin θ \vert & ( second and fourth quadrants )\end{matrix}$$

Equation 8 above may represent a method for determining the weights (W31˜W34) by the weight setting unit 220.

$${w}_{41} ( θ ) = \{ \begin{matrix}1 / 2 \vert cos θ \vert & ( first and third quadrants ) \\ 1 / 2 \vert sin θ \vert & ( second and fourth quadrants )\end{matrix} \qquad [ Equation 9 ]$$

$${w}_{42} ( θ ) = \{ \begin{matrix}0 & ( first and third quadrants ) \\ 1 / 2 \vert cos θ \vert + 1 / 2 \vert sin θ \vert & ( second and fourth quadrants )\end{matrix}$$

$${w}_{43} ( θ ) = \{ \begin{matrix}1 / 2 \vert cos θ \vert + 1 / 2 \vert sin θ \vert & ( first and third quadrants ) \\ 0 & ( second and fourth quadrants )\end{matrix}$$

$${w}_{44} ( θ ) = \{ \begin{matrix}1 / 2 \vert sin θ \vert & ( first and third quadrants ) \\ 1 / 2 \vert cos θ \vert & ( second and fourth quadrants )\end{matrix}$$

Equation 9 above may represent a method for determining the weights (W41˜W44) by the weight setting unit 220.

FIGS. 7(a) to 7(d) are diagrams illustrating phase images for explaining the operation of the signal blending unit 230 shown in FIG. 3 based on some implementations of the disclosed technology.

Referring to FIGS. 7(a) to 7(d), the signal blending unit 230 may add the weight ‘wₘₙ’ determined by the weight setting unit 220 to the pixel values of the phase-difference detection pixels (PX1˜PX4) to create a plurality of phase images (IMG1˜IMG4). Each of the phase images (IMG1˜IMG4) may include a plurality of unit pixels arranged in a (3×4) matrix with 3 rows and 4 columns. Here, the number of phase images (IMG1˜IMG4) may be equal to or less than the number of phase-difference detection pixels (PX1˜PX4). For example, when the number of phase-difference detection pixels (PX1˜PX4) (e.g., pixel regions (LT, LB, RT, RB)) is 4, four phase images (IMG1˜IMG4) can be generated.

The blending operation by the signal blending unit 230 may be performed as shown in Equation 10 below. Equation 10 below illustrates an example of a method for performing the signal blending operation based on the weight ‘wₘₙ’ calculated by Equation 5 described above.

$${r}_{+} ( i , j ) = {w}_{11} * LT + {w}_{12} * RT + {w}_{13} * LB + {w}_{14} * RB \qquad [ Equation 10 ]$$

$${r}_{-} ( i , j ) = {w}_{21} * LT + {w}_{22} * RT + {w}_{23} * LB + {w}_{24} * RB$$

$${t}_{+} ( i , j ) = {w}_{31} * LT + {w}_{32} * RT + {w}_{33} * LB + {w}_{34} * RB$$

$${t}_{-} ( i , j ) = {w}_{41} * LT + {w}_{42} * RT + {w}_{43} * LB + {w}_{44} * RB$$

As shown in Equation 10 above, the signal blending unit 230 may add the weight calculated by Equation 5 to the positions (LT, LB, RT, RB) of each unit pixel (PX1˜PX4), and may perform a blending operation for the phase images (IMG1, IMG2) arranged in the radial direction. Then, the signal blending unit 230 may add the weight calculated by Equation 5 to the positions (LT, LB, RT, RB) of each unit pixel (PX1˜PX4), and may perform the blending operation for the phase images (IMG3, IMG4) arranged in the tangential direction.

In the implementation, the signal blending unit 230 may add the weights (w₁₁, w₁₂, w₁₃, w₁₄) to the positions (LT, LB, RT, RB) of each unit pixel (PX1˜PX4) to create the phase image ‘(IMG1)(r₊(i, j))’. The signal blending unit 230 may add the weights (w₂₁, w₂₂, w₂₃, w₂₄) to the positions (LT, LB, RT, RB) of each unit pixel (PX1˜PX4) to create a phase image ‘(IMG2)(r₋(i,j))’. The signal blending unit 230 may add the weights (w₃₁, w₃₂, w₃₃, w₃₄) to the positions (LT, LB, RT, RB) of each unit pixel (PX1˜PX4) to create the phase image ‘(IMG3)(t₊(i, j))’. The signal blending unit 230 may add the weights (w₄₁, w₄₂, w₄₃, w₄₄) to the positions (LT, LB, RT, RB) of each unit pixel (PX1˜PX4) to create a phase image ‘(IMG4)(t₋(i,j))’.

Phase-difference data (e.g., luminance data) of the phase images (r₊(i,j), r₋(i,j), t₊(i,j), t₋(i,j)) calculated by the signal blending unit 230 may be stored in the memory 210 (e.g., a buffer) described above.

In some other implementations, the blending operation by the signal blending unit 230 may be performed as shown in Equation 11 below. Equation 11 below illustrates an example of a method for performing the signal blending operation based on the weight ‘wₘₙ’ calculated by Equations 6 to 9 described above.

$${r}_{+} ( i , j ) = {w}_{11} * {n}_{h} {n}_{y} + {w}_{12} * {n}_{h} {f}_{y} + {w}_{13} * {f}_{h} {n}_{y} + {w}_{14} * {f}_{h} {f}_{y} \qquad [ Equation 11 ]$$

$${r}_{-} ( i , j ) = {w}_{21} * {n}_{h} {n}_{y} + {w}_{22} * {n}_{h} {f}_{y} + {w}_{23} * {f}_{h} {n}_{y} + {w}_{24} * {f}_{h} {f}_{y}$$

$${t}_{+} ( i , j ) = {w}_{31} * {n}_{h} {n}_{y} + {w}_{32} * {n}_{h} {f}_{y} + {w}_{33} * {f}_{h} {n}_{y} + {w}_{34} * {f}_{h} {f}_{y}$$

$${t}_{-} ( i , j ) = {w}_{41} * {n}_{h} {n}_{y} + {w}_{42} * {n}_{h} {f}_{y} + {w}_{43} * {f}_{h} {n}_{y} + {w}_{44} * {f}_{h} {f}_{y}$$

As shown in Equation 11 above, the signal blending unit 230 may add the weights (w₁₁˜w₂₄) calculated by Equations 6 to 9 to the positions (nₕnᵥ, nₕfᵥ, fₕnᵥ, fₕfᵥ) of each unit pixel (PX1˜PX4), and may perform the blending operation for the phase images (IMG1, IMG2) arranged in the radial direction. The signal blending unit 230 may add the weights (w₃₁˜w₄₄) calculated by Equations 6 to 9 to the positions (nₕnᵥ, nₕfᵥ, fₕnᵥ, fₕfᵥ) of each unit pixel (PX1˜PX4), and may perform the blending operation for the phase images (IMG3, IMG4) arranged in the tangential direction.

FIG. 8(a) is a diagram illustrating a method for calculating a radial parallax by the parallax calculator 240 of FIG. 3, and FIG. 8(b) is a diagram illustrating a method for calculating a tangential parallax by the parallax calculator 240 of FIG. 3.

Referring to FIG. 8(a), the phase image IMG1 and the phase image IMG2 may have a radial disparity (RD) caused by a parallax in the radial direction (hereinafter referred to as a radial parallax). Here, the radial direction may refer to a direction proceeding from the optical-axis center point (CP) of an image (e.g., a circular image) toward the edge of the image. The radial parallax may indicate meridional distortion of the lens with respect to the image. Thus, the radial parallax may represent a disparity (i.e., radial disparity RD) for a radius distance from the optical-axis center point of the image to the edge of the image. For example, the radial parallax may occur due to non-uniformity in the refractive index of the lens.

The phase image (IMG1) with a relatively large radial disparity (RD) can be defined as an “r₊” image with positive radial distortion. For example, the “r₊” image may have a relatively long radius based on the center point (CP). Additionally, the phase image (IMG2) with relatively small radial disparity (RD) can be defined as an “r₋” image with negative radial distortion. For example, the “r₋” image may have a relatively short radius based on the center point (CP).

Referring to FIG. 8(b), each of the phase image IMG3 and the phase image IMG4 may have a tangential disparity (TD) caused by a parallax in the tangential direction (hereinafter referred to as a tangential parallax). Here, the tangential direction may be a direction perpendicular to the radial direction. The tangential parallax may represent a decentering distortion from a sagittal direction of the lens with respect to an image (e.g., a circular image). Thus, the tangential parallax may represent the tangential disparity (TD) in which the images are not parallel to each other and are misaligned at a certain angle based on the vertical line (VL) that vertically crosses the optical-axis center point (CP) of the image and the horizontal line (HL) that horizontally crosses the optical-axis center point (CP) of the image. For example, the tangential parallax may occur due to distortion of the optical axis between the image sensor and the lens.

The phase image (IMG3) with a relatively large tangential disparity (TD) can be defined as a “t₊” image with positive tangential distortion. For example, the “t₊” image may be rotated to the right using the center point (CP) as the rotation axis. Additionally, the phase image (IMG4) with a relatively small tangential disparity (TD) can be defined as a “t₋” image with negative tangential distortion. For example, the “t₋” image may be rotated to the left using the center point (CP) as the rotation axis.

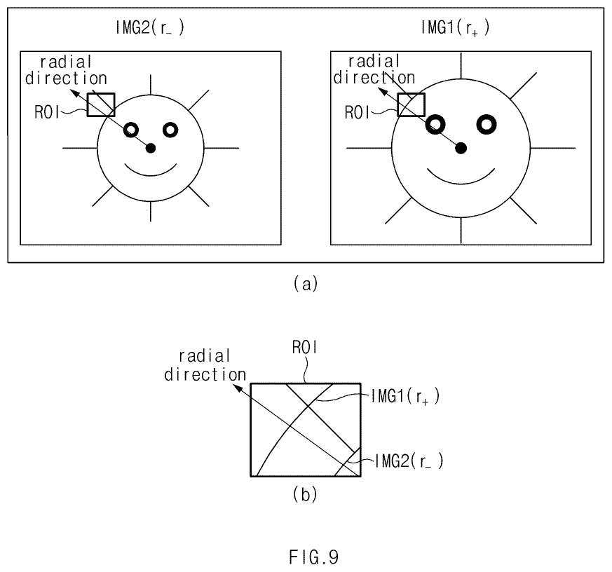

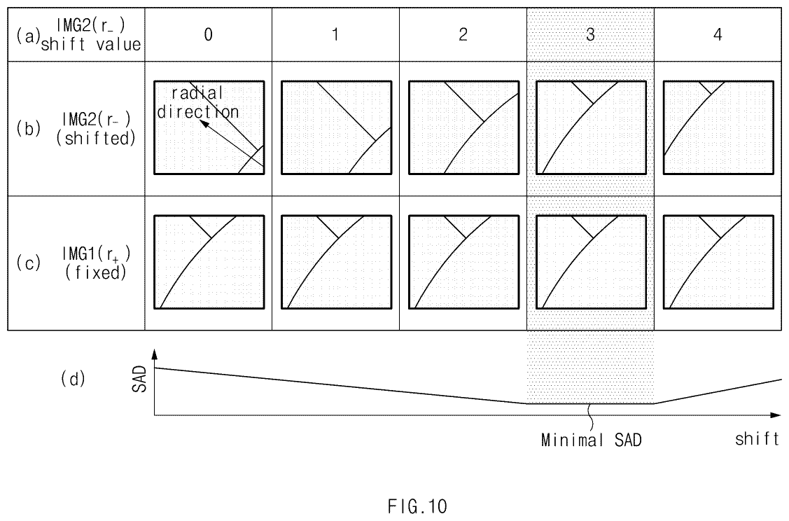

FIGS. 9 and 10 are diagrams illustrating example operations for calculating the radial parallax by the parallax calculator 240 shown in FIG. 3 based on some implementations of the disclosed technology.

FIG. 9(a) illustrates the phase images (IMG1, IMG2) of FIG. 8 described above. The region denoted by a square box may represent a focus detection region, that is, the region of interest (ROI). In the embodiment of FIG. 9, an image of a portion of the left top (LT) region of the circular image is set as a region of interest (ROI), but this is only an example and the number of ROIs and the size of each ROI (i.e., the number of pixels included in each ROI) can be changed in various implementations.

When the ROI of FIG. 9(a) is enlarged as shown in FIG. 9(b), it can be seen that each of the phase images (IMG1(r₊), IMG2(r₋)) has a radial parallax. Accordingly, the parallax calculator 240 may calculate a parallax between the phase images (IMG1(r₊), IMG2(r₋)), and may output a disparity value corresponding to the calculated parallax.

In some implementations, the parallax calculator 240 may calculate a parallax according to a method of performing a correlation operation on data. The correlation operation method may obtain a data correlation value with a reference pixel (e.g., a pixel of the image IMG1) while radially shifting the position of a pixel (e.g., a pixel of the image IMG2) to be used as a target of correlation operation.

Here, examples of the correlation operation may include SAD (sum of absolute difference), SSD (sum of squared difference), NCC (normalized cross-correlation), ZNCC (zero-mean normalized cross-correlation), census transform, AD-Census (absolute differences census transform), or others. In some implementations, the parallax calculator 240 may apply various other methods than the correlation operation to calculate the parallax.

The embodiment of FIGS. 10(a)-10(d) shows an example of a method for calculating the parallax using the SAD method. FIG. 10(a) may represent a pixel shift value obtained when the position of the region of interest (ROI) of the phase image IMG2 is shifted. FIG. 10(b) may represent a shift state in which the ROI position of the phase image IMG2 is shifted. FIG. 10(c) may represent a fixed state in which the ROI position of the phase image IMG1 is fixed without being shifted. The parallax calculator 240 may extract a correlation operation graph based on the SAD value, as shown in FIG. 10(d).

In the implementation, the parallax calculator 240 may calculate the SAD value based on a difference between shift values while radially shifting the region of interest (ROI) of the target phase image (IMG2) based on the phase image (IMG1), and may calculate a disparity value for the target object. Here, the sum of absolute values of difference values between two image data to be used as a target of correlation operation can be defined as the SAD value.

In some implementations, the parallax calculator 240 may calculate a disparity (e.g., ‘3’) as a pixel shift amount that can minimize the SAD value in the correlation operation graph. The parallax calculator 240 may also calculate a parallax by calculating an offset of the peak position in the radial or tangential direction using the cross-correlation method. The parallax value calculated by the parallax calculator 240 can be used to adjust the focus position as well as to detect depth information, etc.

When the imaging device 1 performs the initial focus detection process, if the disparity is determined to be zero ‘0’, this means that accurate focus has been detected. When the imaging device 1 determines that the disparity is not zero ‘0’, the addition range of the phase-difference detection pixels can be controlled.

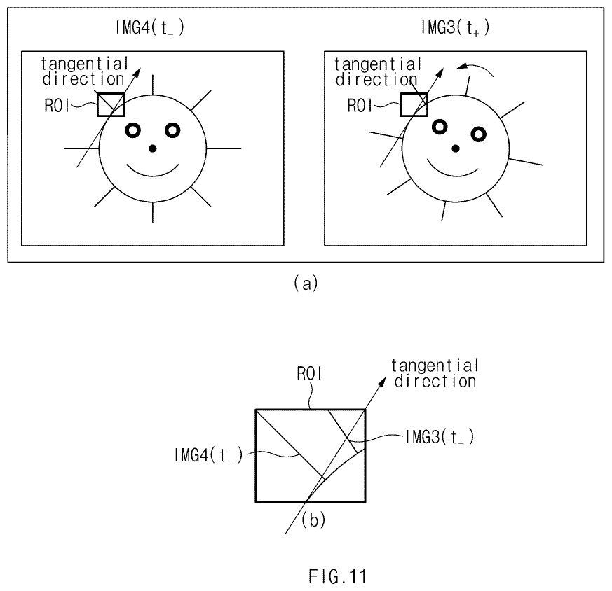

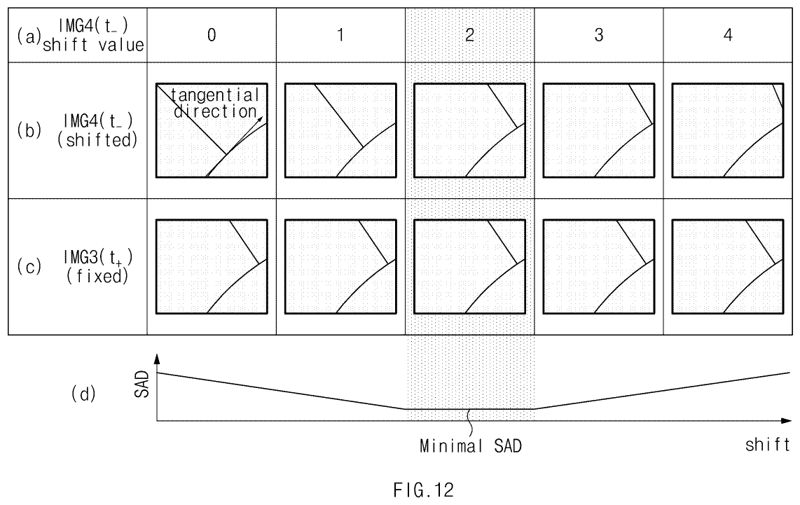

FIGS. 11(a)-11(b) and 12(a) to 12(d) are diagrams illustrating example operations for calculating the tangential parallax by the parallax calculator 240 shown in FIG. 3 based on some implementations of the disclosed technology.

FIG. 11(a) may represent the phase images (IMG3, IMG4) of FIGS. 7(a) to 7(d) described above. The region denoted by a dotted line may represent a focus detection region, that is, the region of interest (ROI). In the embodiment of FIGS. 11(a) and 11(b), an image of a portion of the left top (LT) region of the circular image is set as the region of interest (ROI), but this is only an example, and the number of ROIs and the size of each ROI (i.e., the number of pixels included in each ROI) can be changed in various implementations.

When the ROI of FIG. 11(a) is enlarged as shown in FIG. 11(b), it can be seen that each of the phase images (IMG3(t₊), IMG4(t₋)) has a tangential parallax. Accordingly, the parallax calculator 240 may calculate a parallax between the phase images (IMG3(t₊), IMG4(t₋)), and may output a disparity value corresponding to the calculated parallax.

In some implementations, the parallax calculator 240 may calculate a data correlation value with a reference pixel (e.g., a pixel of the image IMG3) while tangentially shifting the position of a pixel (e.g., a pixel of the image IMG4) to be used as a target of correlation operation.

The embodiment of FIGS. 12(a)-12(d) shows an example of a method for calculating the parallax using the SAD method. FIG. 12(a) may represent a pixel shift value obtained when the position of the region of interest (ROI) of the phase image IMG4 is shifted. FIG. 12(b) may represent a shift state in which the ROI position of the phase image IMG4 is shifted. FIG. 12(c) may represent a fixed state in which the ROI position of the phase image IMG3 is fixed without being shifted. The parallax calculator 240 may extract a correlation operation graph based on the SAD value, as shown in FIG. 12(d).

In the implementation, the parallax calculator 240 may calculate the SAD value according to a difference between shift values while tangentially shifting the region of interest (ROI) of the target phase image (IMG4) based on the phase image (IMG3), and may calculate a disparity value for the target object. In some implementations, the parallax calculator 240 may calculate the value of ‘2’ at which the SAD is minimized in the correlation calculation graph, as the disparity value. For example, a minimum SAD value in the correlation operation graph may vary depending on noise in the input image.

As is apparent from the above description, the imaging device based on some implementations of the disclosed technology can accurately adjust a focus position in an image sensing device including PDAF pixels.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An imaging device comprising:
a pixel array configured to include a plurality of image detection pixels configured to detect light from a target object and to output image signals for generating an image of the target object and a plurality of phase-difference detection pixels configured to detect phase difference information in light rays from the target object;
a position determiner configured to determine a position of each unit pixel in the pixel array;
a weight setting unit configured to set different weights for each position of each phase-difference detection pixel based on an output signal of the position determiner;
a signal blending unit configured to generate a plurality of phase images by adding the weight set by the weight setting unit to each of the phase-difference detection pixels;
a parallax calculator configured to calculate a parallax in at least one of a first direction proceeding from a center point of an optical axis in the plurality of phase images or a second direction different from the first direction; and
a focus position determiner configured to generate a driving signal for adjusting a position of a lens based on the parallax calculated by the parallax calculator.

2. The imaging device according to claim 1, wherein:
the pixel array includes a plurality of pixel groups,
wherein each of the plurality of pixel groups includes a plurality of unit pixels arranged in a matrix,
wherein the plurality of unit pixels has color filters of a same color and shares one microlens.

3. The imaging device according to claim 1, wherein the position determiner is configured to:
count position values of pixels corresponding to indices of unit pixels arranged in a row direction within the pixel array and position values of pixels corresponding to indices of unit pixels arranged in a column direction within the pixel array; and
sequentially read out data of the pixels.

4. The imaging device according to claim 1, wherein the position determiner is configured to:
determine the position of each unit pixel by detecting angle information between the optical axis and each unit pixel on the pixel array.

5. The imaging device according to claim 4, wherein the position determiner is configured to:
divide the pixel array into quadrants based on a horizontal line crossing the center point of the optical axis in a horizontal direction and a vertical line crossing the center point of the optical axis in a vertical direction;
determine a position of a target pixel group based on a distance between the center point and each of the unit pixels respectively located in the quadrants; and
calculate the angle information in response to the optical axis and the position of the pixel group.

6. The imaging device according to claim 1, wherein:
the pixel array is divided into quadrants based on a horizontal line crossing the center point of the optical axis in a horizontal direction and a vertical line crossing the center point of the optical axis in a vertical direction; and
the weight setting unit is configured to differently set the weight in each quadrant of the pixel array.

7. The imaging device according to claim 1, wherein:
the number of the plurality of phase images is equal to or less than the number of the plurality of phase-difference detection pixels.

8. The imaging device according to claim 1, wherein the signal blending unit is configured to generate:
a first phase image having positive radial distortion in the first direction; and
a second phase image having negative radial distortion in the first direction.

9. The imaging device according to claim 8, wherein:
the first direction is a radial direction from the center point of the optical axis toward edges of the first phase image and the second phase image.

10. The imaging device according to claim 8, wherein:
the radial distortion has a disparity with respect to a radius distance from the center point of the optical axis to edges of the first phase image and the second phase image.

11. The imaging device according to claim 8, wherein the parallax calculator is configured to:
shift the position of the second phase image in the first direction; and
calculate a parallax according to a data correlation value with the first phase image.

12. The imaging device according to claim 1, wherein the signal blending unit is configured to generate:
a third phase image having positive tangential distortion in the second direction; and
a fourth phase image having negative tangential distortion in the second direction.

13. The imaging device according to claim 12, wherein:
the second direction is a tangential direction perpendicular to the first direction.

14. The imaging device according to claim 12, wherein:
the tangential distortion has a disparity at which each of the first phase image and the second phase image deviates from the center point of the optical axis by a predetermined angle.

15. The imaging device according to claim 12, wherein the parallax calculator is configured to:
shift the position of the fourth phase image in the second direction; and
calculate a parallax according to a data correlation value with the third phase image.

16. The imaging device according to claim 1, wherein the parallax calculator is configured to:
obtain data correlation values of two phase images from among the plurality of phase images; and
calculate a disparity value at which the data correlation values are minimized.

17. An imaging device comprising:
a pixel group including a plurality of unit pixels arranged in a matrix and operable to detect input light from a target object to capture an image of the target object and a plurality of phase-difference detection pixels configured to detect phase difference information in light rays from the target object to produce pixel values carrying the phase difference information; and
an image signal processor configured to generate a plurality of phase images by adding different weights for each position of the plurality of unit pixels to the pixel values of the phase-difference detection pixels, and calculate a parallax for the plurality of phase images in at least one of a first direction proceeding from a center point of an optical axis or a second direction perpendicular to the first direction.

18. The imaging device according to claim 17, wherein:
the pixel group has color filters of a same color and shares one microlens.

19. The imaging device according to claim 17, wherein the image signal processor is configured to:
calculate the parallax in the first direction, the parallax being a disparity with respect to a radius distance from the center point of the optical axis to edges of the plurality of phase images.

20. The imaging device according to claim 17, wherein the image signal processor is configured to:
calculate the parallax in the second direction, the parallax being a disparity at which the plurality of phase images deviates from the center point of the optical axis by a predetermined angle.
